(19) United States
(12) Patent Application Publication
(10) Pub. No.: US 2009/0089588 A1
(43) Pub. Date: Apr. 2, 2009

(54) METHOD AND APPARATUS FOR PROVIDING ANTI-THEFT SOLUTIONS TO A COMPUTING SYSTEM

(76) Inventors: Farid Adrangi, Lakes Oswego, OR (US); Hani Elgebaly, Beaverton, OR (US); Rahul Bhatt, El Dorado Hills, CA (US)

Correspondence Address: Guojun Zhou;Intel Corporation, c/o Intellevate, LLC, P.O. Box 52050, Minneapolis, MN, 55402, US

(21) Appl. No.: 11/940,402

(22) Filed: Nov. 15, 2007

Related U.S. Application Data
(63) Continuation-in-part of application No. 11/864,822, filed on Sep. 28, 2007, now abandoned.

(51) Int. Cl. H04L 9/32; G06F 21/00

(52) U.S. Cl. 713/183; 726/19

(57) ABSTRACT

A manageability engine (ME) may be used to authenticate a user for a computer system. A data collection module may be coupled to the ME to collect data (e.g., fingerprint image, facial images, speech, etc.) from a user. The ME processes the collected data to authenticate the user. If the authentication is successful, the system may boot, resume from a sleep state, or become re-accessible by the user; otherwise, the user is prevented from using the system or accessing data stored therein.

### RELATED PATENT APPLICATION

This application is a continuation-in-part of the U.S. patent application No. 11/864,822, entitled “Method and Apparatus for Providing Anti-theft solutions to a computing system,” filed on Sep. 28, 2007 by Farid Adrangi and Hani Elgebaly, and claims priority thereto.

### BACKGROUND

1. Field

This disclosure relates generally to computer systems, and more specifically but not exclusively, to methods and apparatus for securing a computer system from theft.

2. Description

The number of personal computer (PC) thefts increases year by year and PC thefts continue to be a problem worldwide. One of main motives for PC thefts is to sell stolen PCs or turn theft PCs for self use. If there is a security measure that could prevent sale or use of a stolen PC, this would help reduce the number of PC thefts. Most computing systems nowadays have many security features including features for preventing unauthorized users from starting up or accessing data in a computer system. For example, a computer system may have a BIOS (basic input and output system) password, an HDD (hard disk drive) password, a HDD encryption key, an OS (operating system) sign-on password, and so on. Some high end notebooks are integrated with a finger print device to provide strong authentication to the computer. However, these security measures are not adequate to discourage/reduce PC thefts because those security measures may easily be removed or disabled. Therefore, it is desirable to have a more secure measure to prevent/reduce PC thefts.

### BRIEF DESCRIPTION OF THE DRAWINGS

The features and advantages of the disclosed subject matter will become apparent from the following detailed description of the subject matter in which:

FIG. 1 shows a block diagram of a computer system with a manageability engine where an embodiment of the subject matter disclosed in the present application may be implemented;

FIG. 2 shows a flowchart of an example process for authenticating a user when a computer system boots or resumes, according to an embodiment of the subject matter disclosed in the present application; and

FIG. 3 shows a flowchart of another example process for re-authenticating a user after a computer system boots or resumes, according to an embodiment of the subject matter disclosed in the present application.

### DETAILED DESCRIPTION

According to embodiments of the subject matter disclosed in this application, a data collection module may be directly connected to a manageability engine (ME) to collect data (e.g., fingerprint image, face image, speech, etc.) from a user. The ME uses the collected data to authenticate the user. The collected data is securely processed by the ME. If the collected data match a pre-stored model, the user may pass the authentication and may use the protected PC. In case of authentication failure, the ME prevents the BIOS from starting and data stored in the PC remain protected. Additionally if a PC is stolen when it is a working state (e.g., ACPI (Advanced Configuration and Power Interface) S0 state), the ME may re-authenticate the user. For example, if the PC remains in the working state continuously beyond predetermined time duration, the ME may re-authenticate the user. If the user fails the re-authentication, the ME will prevent the PC from being used. In any case, a user is prevented from using the PC or accessing any data stored therein if the user fails the authentication or re-authentication.

Reference in the specification to “one embodiment” or “an embodiment” of the disclosed subject matter means that a particular feature, structure or characteristic described in connection with the embodiment is included in at least one embodiment of the disclosed subject matter. Thus, the appearances of the phrase “in one embodiment” appearing in various places throughout the specification are not necessarily all referring to the same embodiment.

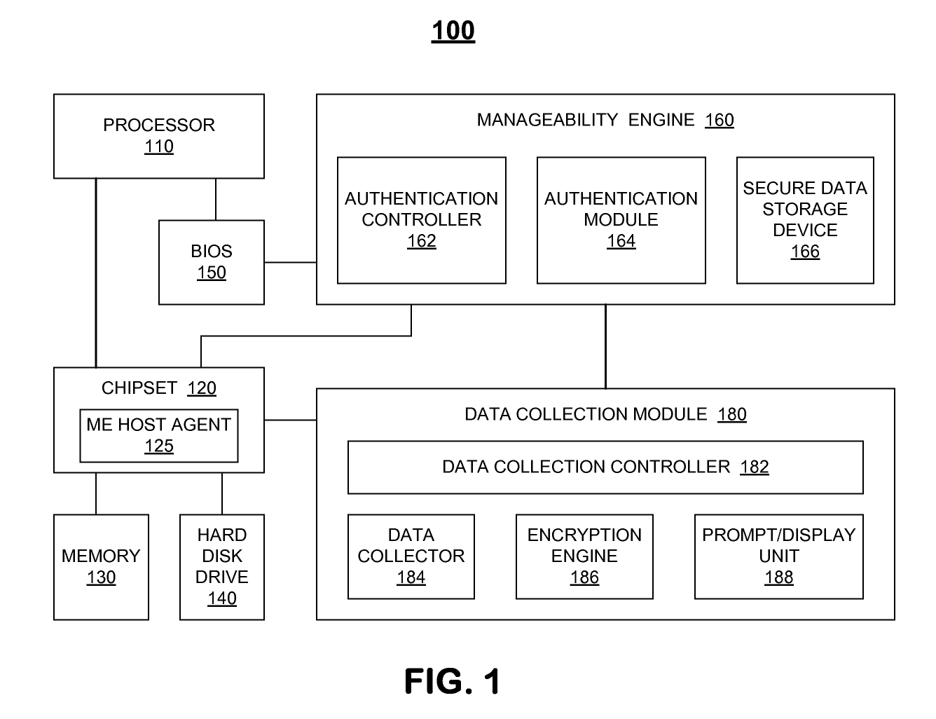

FIG. 1 shows a block diagram of a computer system 100 with a manageability engine where an embodiment of the subject matter disclosed in the present application may be implemented. As a typical computer system, system 100 includes at least one processor 110 which is coupled to a chipset 120 via a system bus. The processor may include more than one processing cores. Processor 110 may represent multiple processors in the system 100. Chipset 120 may include one or more integrated circuit packages or chips. Chipset 120 may comprise one or more device interfaces to support data transfers to and/or from other components of the computing system 100 such as, for example, keyboards, mice, network interfaces, etc. The device interface may be coupled with other components through a bus. Chipset 120 may include an audio controller that provides a data path between audio codec (not shown) and processor 110 as well as main memory 130.

Additionally, chipset 120 may comprise a memory controller (not shown) that is coupled to a main memory 130 through a memory bus. The main memory 130 may store data and sequences of instructions that are executed by the processor 110 or any other device included in the system. The memory controller may access the main memory 130 in response to memory transactions associated with processor 110, and other devices in the computing system 100. In one embodiment, memory controller may be located in processor 110 or some other circuitries. The main memory 130 may comprise various memory devices that provide addressable storage locations which the memory controller may read data from and/or write data to. The main memory 130 may comprise one or more different types of memory devices such as Dynamic Random Access Memory (DRAM) devices, Synchronous DRAM (SDRAM) devices, Double Data Rate (DDR) SDRAM devices, or other memory devices.

Moreover, chipset 120 may include a disk controller (not shown in the figure) coupled to a hard disk drive (HDD) 140 (or other disk drives) through a bus. The disk controller allows processor 110 to communicate with the HDD 140. In some embodiments, the disk controller may be integrated into a disk drive (e.g., HDD 140). There may be different types of buses coupling the disk controller and HDD 140, for example, the ATA (Advanced Technology Attachment) bus and PCI (Peripheral Component Interconnect) Express (PCI-E) bus. Data stored in HDD 140 is encrypted and/or protected through the ME 160. A user can access the data stored in the HDD only if the user passes authentication or re-authentication via the ME. In other words, if the user fails authentication or re-authentication, the user is prevented from accessing any data stored in the HDD. Additionally, chipset 120 may include an ME host agent 125 which is described below.

The computing system includes BIOS (Basic Input/Output System) 150, the built-in software that determines what a computer can do without accessing programs from a disk. On PCs, the BIOS contains all the code required to control the keyboard, display screen, disk drives, serial communications, and a number of miscellaneous functions. The BIOS is typically placed in a ROM (Read Only Memory) chip that comes with the computer. This ensures that the BIOS will always be available and will not be damaged by disk failures. It also makes it possible for a computer to boot itself. Many PCs have a flash BIOS, which means that the BIOS has been recorded on a flash memory chip, which can be updated if necessary. BIOS 150 helps the computing system to boot.

The computing system 100 is coupled to a manageability engine (ME) 160, part of a platform level solution that can dynamically control the functionality of the network hardware based on network activity. ME 160 monitors connections opened per second and will shutdown the NIC (Network Interface Card/Controller) if software attempts to open more connections per second than a certain threshold determines is appropriate. Typically, a solution that uses an ME to prevent the BIOS from starting when authentication fails is more secure because the ME is integrated with the chipset and it is much more difficult to be hacked or removed. ME 160 has its own processor and memory and is isolated from processor 110. Additionally, ME 160 may detect the removal of the data collection module and disable system 100. ME 160 may be modified to include an authentication controller 162, an authentication module 164, and a security date storage device 166.

Authentication controller 162 controls when BIOS 150 should be activated to boot the system. Authentication module 164 receives data collected from a user by data collection module 180 and decrypts the data if the data is encrypted. Subsequently authentication module 164 processes the data. If the data is a fingerprint image, authentication module 164 may compare the fingerprint data with a fingerprint model pre-stored in secure data storage device 166. Well known fingerprint recognition technologies may be used to recognize the collected fingerprint image. If the collected data is a face/eye image, authentication module 164 may use a well-known face/eye recognition/authentication technology to process the face/eye data to determine if the data matches a pre-stored face/eye model. If the collected data is speech, authentication module 164 may use a well-known speech/speaker recognition/identification technology to process the speech data to determine if the user is authorized to use the computing system 100. In one embodiment, the collected data may include a mixture of multiple types of data such as fingerprint image plus speech samples. In this case, authentication module 164 may process different types of data separately or use a well-known technology to process the mixture of data jointly. For example, if the collected data include speech samples and their corresponding facial images, authentication module 164 may use a well-known audio-visual processing technology to jointly process the audio visual data in determining if the user is authorized to use the system. Examples described herein are for illustration purpose, other variations/combinations are possible.

Secure data storage device 166 may store data used by authentication module 164. For example, secure data storage device may be used to temporarily store the user data collected by data collection module 180 and/or to store models/templates used for authentication purpose. If the authentication module uses speech/speaker recognition/identification technology, secure data storage device 166 may store language models (e.g., uni-grams, bi-grams, or tri-grams) and acoustic models for acoustic units such as triphones. In addition to authentication function, authentication module may generate models/templates used for authentication purpose. For example, the authentication module may acquire sample speech during an enrollment process (when system 100 is in the working state), and obtain acoustic/language models through some training algorithms using the acquired sample speech as input. Moreover, secure data storage device 166 may store other data needed by ME 160 to perform functions other than user authentication. Furthermore, ME 160 may comprise a wakeup mechanism (not shown in the figure) to wake the ME when data collection module detects any user data entry activity.

Computer system 100 may also include a data collection module 180 to collect data from a user for authenticating the user. Data collection module 180 may comprise a data collection controller 182, a data collector 184, an encryption engine 186, and a prompt/display unit 188. Data collector 184 collects data from the user and may comprise a sensor such as a fingerprint scanner, a camera for visual input, a microphone (or a microphone array) for audio input, a card reader, and etc. Data collector 184 may digitize the data collected from the user. Encryption engine 186 may encrypt the collected data and may also compress the data for secure and efficient data transfer from data collection module 180 to ME 160. Prompt/display unit 188 may prompt a user when s/he should provide data and indicate to the user whether authentication passes or fails. For example, prompt/display unit 188 may include a LED (Light Emitting Diode). When the LED blinks yellow, the user can enter the data (e.g., swipe fingers/card, move forward to have facial pictures taken, speak toward to the microphone, etc.). When the LED shows solid red, it means that authentication has failed. When the LED shows solid green, it means that authentication passes and the user can use the system 100. In another example, prompt/display unit 188 may include audio/video player to prompt the user to provide the data and indicate the authentication result to the user.

Data collection controller 182 coordinates among and controls the functioning of data collector 184, encryption engine 186, and prompt/display unit 188. For example, data collection controller 182 may direct prompt/display unit 188 when to prompt the user or display information to the user. When a user boots system 100 or resumes system 100 from the ACPI S4/S5 state, the data collection controller may direct prompt/display unit 188 to prompt the user to provide data for authentication. Data collection controller 182 may control how data collector 184 should work and pass data collected from data collector 184 to encryption engine 186 for encryption. Additionally, data collection controller 182 may decide when and how to transfer the collected/encrypted data to ME 160. Moreover, data collection controller 182 may send a signal to wake up ME 160 upon detecting any data entry activity by a user.

Data collection module 180 may be coupled to ME 160 through a system management bus (SMBus) or a dedicated hardware link. Communications between data collection module 180 and ME 160 is encrypted via the keys which may be provisioned in the data collection module and the ME at the manufacturing time for initial configuration phase. Data collection module 180 may also be coupled to chipset 120 via a bus such as USB (Universal Serial Bus).

Data collection module 180 and ME 160 may work together to provide user authentication after system 100 has been booted up. For example, when system 100 transitions from an ACPI S3 state to an ACPI S0 state or if system 100 remains in an ACPI S0 state continuously beyond a predetermined time period, data collection module 180 and ME 160 may require the user to be re-authenticated. In such a post-boot situation, ME 160 may activate data collection module 180 when a user tries to access system 100. Upon activation, prompt/display unit 188 may prompt the user to provide data for authentication. Upon receiving the data, data collection module 188 may pass the data to a host authentication stack in processor 110, which further passes the data to ME 160 through ME host agent 125. In one embodiment, ME host agent 125 may be integrated with chipset 120. In another embodiment, ME host agent 125 may be physically separate from chipset 120 but coupled to chipset 120.

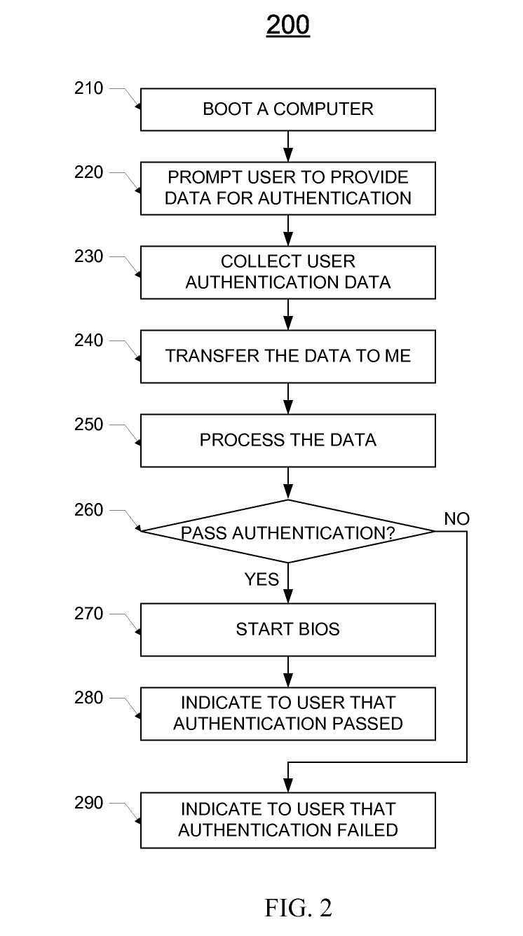

FIG. 2 shows a flowchart of an example process 200 for authenticating a user when a computer system boots or resumes, according to an embodiment of the subject matter disclosed in the present application. At block 210, a user may power on a computer system or resume the system from a sleep state (e.g., ACPI S4/S5 state). Upon detecting the user's action, the user may be prompted to provide data for authentication at block 220. At block 230, data provided by the user may be collected. At block 240, the collected data may be transferred to an ME over an SMBus or a hardware link. At block 250, the collected data may be processed by the ME to authenticate the user. At block 260, a decision whether the user passes authentication may be made by the ME. If the user passes authentication, the ME may start BIOS of the computer system, which then boots the system or resumes the system from an ACPI S4/S5 state at block 270. At block 280, the user may be informed that s/he has passed the authentication. If the user fails authentication, the user may be informed of the authentication failure at block 290. In one embodiment, the user may be prompted to retry authentication for a limited number of times if initial authentication(s) fails.

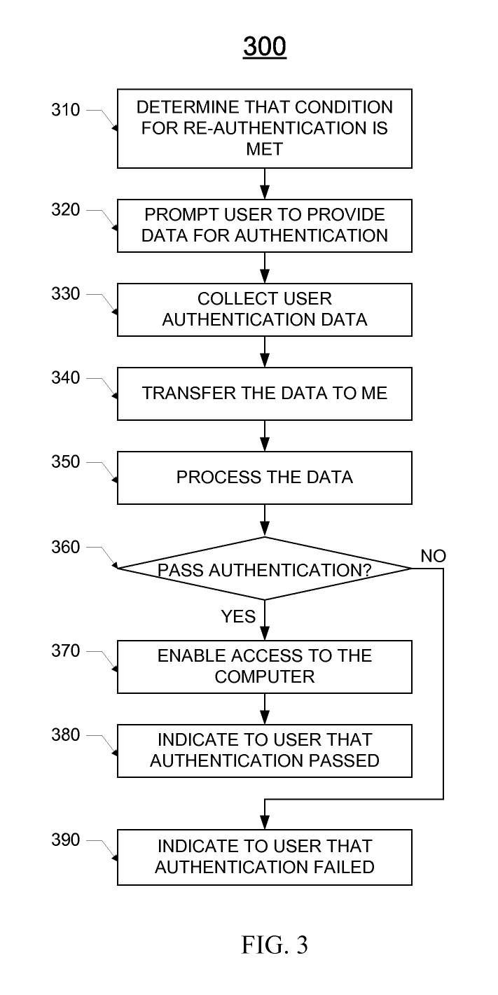

FIG. 3 shows a flowchart of another example process 300 for re-authenticating a user after a computer system boots or resumes, according to an embodiment of the subject matter disclosed in the present application. At block 310, it may be determined that a re-authentication is required. For example, a user tries to resume the computer from a shallow sleep state (e.g., an ACPI S3 state) or the system remains in the working state (e.g., ACPI S0 state) continuously beyond a predetermined time duration. In the latter situation, if there is no authentication, a computer stolen while in an ACPI S0 state may be kept in ACPI S0 state for the remaining of its life. Upon detecting the user's action, the user may be prompted to provide data for authentication at block 320. At block 330, data provided by the user may be collected. At block 340, the collected data may be passed to an authentication stack hosted in a processor of the computer system, from which the collected data may be further transferred to an ME. At block 350, the collected data may be processed by the ME to re-authenticate the user. At block 360, a decision whether the user passes re-authentication may be made by the ME. If the user passes re-authentication, the ME may allow the user to access the computer system or resume from the shallow sleep state at block 370. At block 380, the user may be informed that s/he has passed re-authentication. If the user fails re-authentication, the user may be informed of the re-authentication failure at block 390. In one embodiment, the user may be prompted to retry re-authentication for a limited number of times if initial re-authentication effort(s) fails.

In general, a user must pass authentication in order to use a computing system or access data stored therein, if the computing system has to be boot through its BIOS in order to be used. If the computing system does not need to be boot/re-boot through its BIOS in order to be used, the user must pass re-authentication in order to continue using the computing system or continue accessing the data stored therein. In other words, the computing system and data stored therein can be useful only if a user passes authentication or re-authentication.

Although an example embodiment of the disclosed subject matter is described with reference to drawings in FIGS. 1-3, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method, comprising:
determining if a condition for authenticating a user of a computing system is met;
if the condition is met, prompting the user to provide data for authentication;
authenticating the user using the data collected from the user by a manageability engine (ME); and
if the user fails authentication, preventing the user from accessing the computer system by the ME.

2. The method of claim 1, wherein the condition for authenticating a user comprises detecting a user action to boot the computing system or resuming the computing system from a deep sleep state.

3. The method of claim 2, further comprising:
waking up the ME when the user provides data for authentication;
collecting the data from the user;
encrypted the collected data; and
transferring the encrypted data to the ME.

4. The method of claim 3, wherein transferring the encrypted data to the ME comprises transferring the data to the ME through a system management bus.

5. The method of claim 3, further comprising allowing a Basic Input/Output System (BIOS) of the computing system to boot the computing system if user authentication passes or allowing the user to resume the computing system from the deep sleep state.

6. The method of claim 1, wherein the condition for authenticating a user comprises detecting a user action to resume the computing system from a shallow sleep state, or determining that the computer system remains in a working state continuously beyond a predetermined time duration.

7. The method of claim 6, further comprising:
collecting the data from the user;
passing the collected data to a user authentication application in the computing system; and
transferring the data to the ME.

8. The method of claim 7, further comprising if authentication passes, enabling the user to resume the computing system from the shallow sleep state or to re-access the computing system.

9. A computing system, comprising:
a processor to host an operating system (“OS”), the OS managing resources of the computing system through the processor;
a chipset coupled to the processor to provide communications between the processor and a plurality of devices, the plurality of devices including a system memory and a hard disk drive;
a data collection module coupled to the chipset to collect data from a user to authenticate the user;
a manageability engine (ME) to process the data collected from the user to authenticate the user, and the ME preventing the user from accessing the resources of the computing system if authentication fails.

10. The computing system of claim 9, wherein the data collection module is coupled with the ME through a system management bus.

11. The computing system of claim 9, wherein the data collection module comprises:
a data collector to collect data from the user for authenticating the user;
an encryption engine to encrypt the data collected from the user;
an interface unit to prompt the user to provide data for authentication and to indicate to the user whether authentication passes or fails; and
a controller to coordinate among and control the data collector, the encryption engine, and the interface unit.

12. The computing system of claim 11, wherein the controller wakes up the ME when the user starts providing the data for authentication.

13. The computing system of claim 9, wherein the ME comprises:
an authentication module to receive the data collection for the user, to decrypt the data, and to process the data to authenticate the user;
a secure storage device to store data needed by the authentication module to authenticate the user; and
an authentication controller to control the user's access to the computing system.

14. The computing system of claim 9, wherein the ME authorizes a Basic Input/Output System (BIOS) of the computing system to boot the computing system if the user wants to boot the system and the user is authenticated; or the ME allows the user to resume the computing system from a deep sleep state if the user is authenticated.

15. The computing system of claim 9 wherein the ME re-authenticates the user if the user attempts to resume the computing system from a shadow sleep state or if the computing system remains in a working state continuously beyond predetermined time duration.
